(19) United States
(12) Patent Application Publication
(10) Pub. No.: US 2026/0229214 A1
(43) Pub. Date: Aug. 6, 2026

(54) ACCESSIBLE BIOS ACCESS

(71) Applicant: Lenovo (United States) Inc., Morrisville, NC (US)

(72) Inventors: Rafael Rodrigues Machado, Sorocaba (BR); Angela Martin, Morrisville, NC (US); Xuelian Lin, Apex, NC (US); Emily Truong, Holly Springs, NC (US); Ajay Dholakia, Cary, NC (US); Mike DeMar, Fuquay-Varina, NC (US)

(21) Appl. No.: 19/042,682

(22) Filed: Jan. 31, 2025

(51) Int. Cl. G10L 13/00; G06F 3/0482; G06F 9/4401

(52) U.S. Cl. CPC G10L 13/00; G06F 3/0482; G06F 9/4401

(57) ABSTRACT

One embodiment provides a device, including: receiving, at an information handling device in a pre-operating system environment, an indication to access a BIOS of the information handling device; presenting, in the pre-operating system environment, a BIOS menu comprising a plurality of system software components; receiving, at the BIOS menu while in the pre-operating system environment, a selection of a software component from the plurality of software components; and providing, in response to the selection and utilizing a screen reader device, an audible description of the software component to a user. Other aspects are claimed and described.

### BACKGROUND

Implementation of components within a system directed towards inclusion for all people, including those with disabilities, has been a concentration for device producers for an extended period of time. Universal usability is a concept that promotes inclusion by accounting for disabilities during production design and use. No matter the disability, handicap, etc., devices that were once limited to able-bodied people have been adjusted to address situations for those that struggle with traditional use methods of a device. This concentration on diverse usability of a device helps bridge the gap between traditional device users and those who may be unable to do so, and further encourages a person who may have a disability with the ability to use devices that address some issues that the person with a disability may have with using the device.

### BRIEF SUMMARY

In summary, one aspect provides a method, including: receiving, at an information handling device in a pre-operating system environment, an indication to access a BIOS of the information handling device; presenting, in the pre-operating system environment, a BIOS menu comprising a plurality of system software components; receiving, at the BIOS menu while in the pre-operating system environment, a selection of a software component from the plurality of software components; and providing, in response to the selection and utilizing a screen reader device, an audible description of the software component to a user.

Another aspect provides a device, the device including: a processor; a memory device that stores instructions that, when executed by the processor, causes the device to: receive, in a pre-operating system environment, an indication to access a BIOS of the device; present, in the pre-operating system environment, a BIOS menu comprising a plurality of system software components; receive, at the BIOS menu while in the pre-operating system environment, a selection of a software component from the plurality of software components; and provide, in response to the selection and utilizing a screen reader device, an audible description of the software component to a user.

A further aspect provides a product, the product including: a computer-readable storage device that stores code that, when executed by a processor, causes the product to: receive, in a pre-operating system environment, an indication to access a BIOS of an information handling device; present, in the pre-operating system environment, a BIOS menu comprising a plurality of system software components; receive, at the BIOS menu while in the pre-operating system environment, a selection of a software component from the plurality of software components; and provide, in response to the selection and utilizing a screen reader device, an audible description of the software component to a user

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for providing an audible description of a software component in response to an indication received at an information handing device in a pre-operating system environment.

FIG. 4. provides an example illustration of a screen reader architecture for a pre-operating system environment.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

A user that suffers from a disability may utilize one or more disability assisting components, and/devices, in combination with a traditional information handling device. Such utilization of disability assisting components will account for a user's disability and overcome issues specifically directed to such a component. For example, a user that suffers from partial and/or total deafness may employ a real-time transcription component that will generate a visual transcript for any audible information being relayed to the user. Additionally, for example, a user that may suffer from partial and/or total blindness may utilize a screen reader device to provide an audible description of information selected and/or presented on a display of an information handling device.

These disability assisting components and devices used in combination with an information handling device traditionally rely on an operating system of a device being active. The operating system permits the components to work in combination with additional active components already present on an information handling device in order to provide a thorough description back to a user. For example, the operating system of the information handling device may already have access to language databases that may be used in combination with a screen reader device in order to provide a description to a visually impaired user. However, since these traditional disability assisting devices are limited to being utilized while an operating system is active, a user that suffers from a disability and relies on the use of a disability assisting device will struggle with accessing software components of a device in a pre-operating system environment. What is needed is a system and method that permits the use of a disability assisting device in a pre-operating system environment so that a user with a disability can access pre-operating system components and address any issues present in such an environment.

Accordingly, the described system provides a method for providing an audible description of a software component in response to an indication received while an information handling device is in a pre-operating system environment. In this system, a screen reader device is integrated into an information handling device and permitted to operate in a pre-operating system environment. By being present in a unified extensible firmware interface of a device, a screen reader may have access to BIOS components, and/or a BIOS menu, in order to assist a user that may have a disability, for example, a user that is visually impaired, in understanding what is being presented on a display of an information handling device. Utilizing a screen reader device that is present in a pre-operating system environment may allow a visually impaired user to select a software component present in pre-operating system environment and the screen reader can then audibly supply a description of a selected component to the user, even without the operating system of the device being active.

Such a system and method provide an improvement over traditional systems by allowing access to pre-operating system environment actions of a device through permitting a screen reader device present on an information handling device to operate without the need of an operating system being active. This improvement of accessing software components present within a basic input/output system (BIOS) of a device will allow a user with a visual impairment to access a pre-operating system environment that was previously inaccessible. Traditionally, a user with a visual impairment may struggle with viewing pre-operating system environment information being visually presented on a display of a device since the visually-impaired user is traditionally unable to use accessibility devices in this pre-operating system environment. Thus, the system and method disclosed herein describes a system that will assist visually impaired users with accessing an information handling device's BIOS by audibly providing a description of a selected software component back to the user.

The illustrated example embodiments will be best understood by reference to the figures. The following description is intended only by way of example, and simply illustrates certain example embodiments.

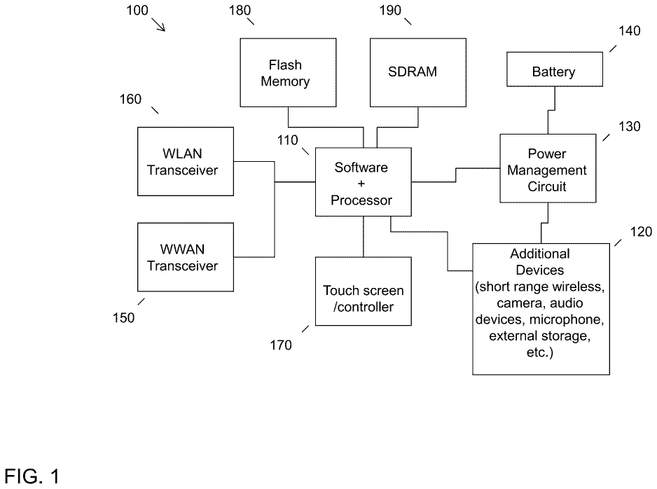

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors include internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

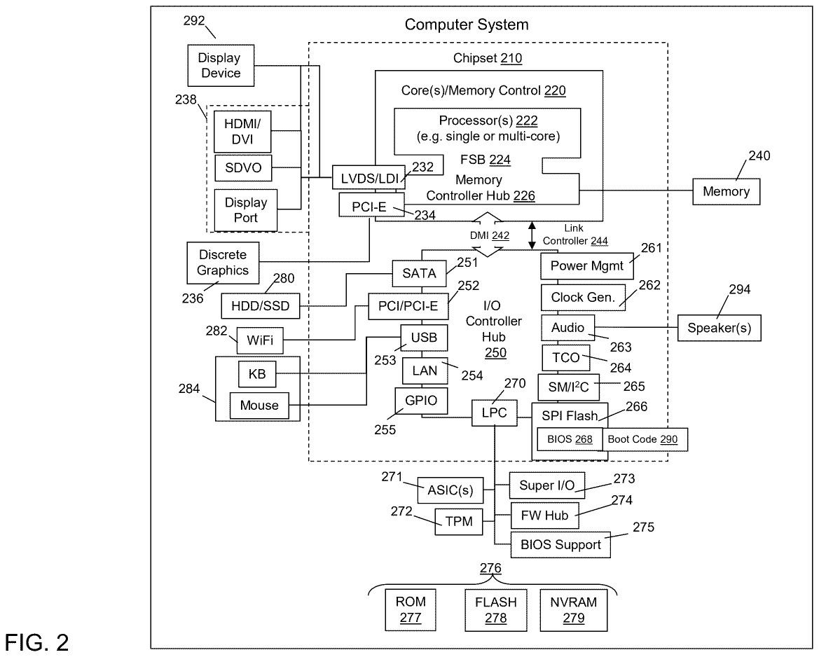

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 include internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may include devices that may be used in connection with the described system and method. For example, the circuitry outlined in FIG. 1 may be implemented in a tablet and/or personal computer environment, whereas the circuitry outlined in FIG. 2 may be implemented in a personal computer embodiment.

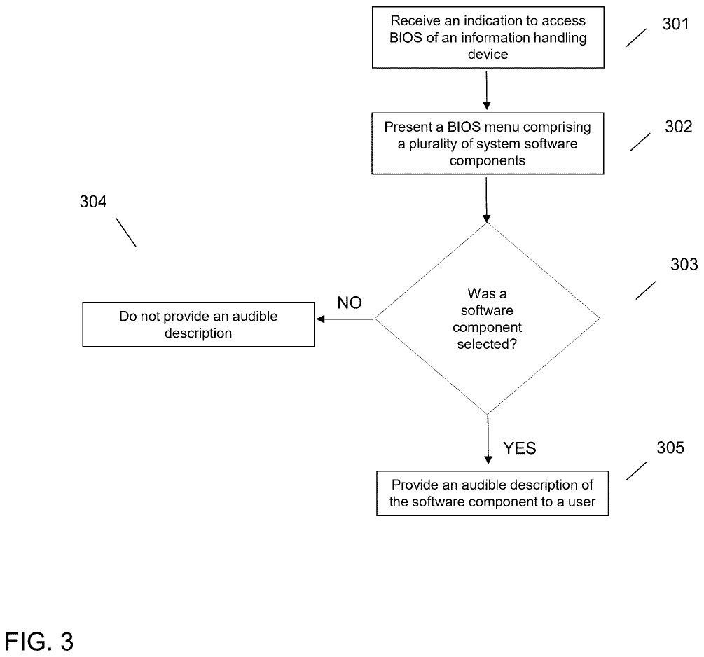

FIG. 3 illustrates an example method for providing an audible description of a software component in response to an indication received at an information handing device in a pre-operating system environment. The method may be implemented on a system which includes a processor, memory device, output devices (e.g., display device, etc.), input devices (e.g., keyboard, touch screen, mouse, microphones, sensors, etc.), and/or other components, for example, those discussed in connection with FIG. 1 and/or FIG. 2. While the system may include known hardware and software components and/or hardware and software components developed in the future, the system itself is specifically programmed to perform the functions as described herein to provide an audible description of a software component in response to an indication received at an information handing device in a pre-operating system environment. Additionally, the screen reader device and described system includes modules and features that are unique to the described system.

Activation of the system may be a manual activation and/or an automatic activation upon power-on an information handling device. The automatic activation may be based upon the detection of a trigger event indicating that the system should be activated.

This system may be made of multiple systems or modules that communicate together to make up a system for providing an audible description of a software component by use of a screen reader device in a pre-operating system environment or may be a single system. The system may be a standalone system, may be accessible through other computing devices, and/or a combination thereof. For example, the system may be a standalone system that can be accessed by a user. The system may be accessible using any type of computing device, for example, personal computer, laptop computer, smartphone, tablet, smartwatch, head-mounted display, smart television or other smart appliance, augmented reality device, virtual reality device, and/or the like.

Thus, the system may be a standalone system, may be accessible through other computing devices, and/or a combination thereof. For example, the system may be a standalone system accessed by a user present on an information handling device. The system may be accessible using any type of computing device, for example, a personal computer, laptop computer, smartphone, tablet, smartwatch, smart television, smart appliance, augmented reality device, virtual reality device, and/or the like. The system may be accessible locally using a computing device where the system is installed. The system may be located and operated on an information handling device to perform the described steps.

At 301, an information handling device may receive an indication for entering an information handling device BIOS while in a pre-operating system environment. A pre-operating system is a single thread environment that offers challenges in that a single thread environment only executes a single command at a time. This causes problems particularly with accessibility solutions because the system will stop answering user input while an accessibility action is processed. In other words, since the single thread environment can only process a single command at a time, it cannot both answer user input and execute accessibility actions at the same time. Thus, using accessibility solutions in a single thread environment causes a loss of responsiveness, due the fact that the processing unit will stop answering user input while the accessibility action is processed if the accessibility action gets triggered automatically by the platforms. At an operating system level, or multi-thread environment, accessibility actions get automatically triggered by platforms even while other commands are executed without issue because the operating system level can process multiple threads at the same time. However, the pre-operating system environment does not allow for such simultaneous processing. The described system and method address this issue and allow for the use of accessibility solutions by only triggering the accessibility action, for example, the provision of speech, when requested by the user, instead of starting the accessibility action automatically and causing the loss of responsiveness.

In the system, upon powering on an information handling device, the BIOS of a device may be utilized to start a computer system of the device. In other words, the BIOS may activate an operating system subsequent to powering on an information handling device. Traditionally, when utilizing a device, an activation of an operating system is desired. However, when an issue arises within a device that is determined to be associated with the BIOS of the device, a user may attempt to access software components of a device prior to activating an operating system. For example, a common BIOS adjustment may include addressing firmware issues, adjusting a boot order of software components upon operating system activation, and/or the like. These actions all occur in a pre-operating system environment.

When a user determines that an adjustment to a software component of a BIOS of an information handling device is required, a user may provide an action to access an information handling device in a pre-operating system (pre-OS) environment. This action for accessing the BIOS may occur immediately after power-on a device, occur after an operating system (OS) of a device has been activated, and/or the like. However, even if the OS is activated, operating in a pre-OS environment may restrict usage of device components, for example, hard disks, peripheral devices (e.g., printers, additional displays, mouse, devices connected through a bus, etc.), and/or the like. Additionally, and/or alternatively, peripheral device components integrally coupled to a device, for example, a display, a keyboard, etc., may still be in operation when a system is operating in a pre-OS environment. Therefore, in the system, an information handling device may receive an indication, from a user, that triggers the device to access a device BIOS while in a pre-operating system environment.

An indication for accessing the device BIOS may include, as mentioned previously, receiving a manual input at the information handling device prior to activating an operating system of the information handling device. Additionally, and/or alternatively, receiving an indication for entering a device BIOS may occur after an operating system has been activated. However, upon receiving the indication to access the device BIOS, an operating system of a device may be bypassed, and/or deactivated, thereby providing a device that is operating in a pre-OS environment to a user. Thus, even if the pre-OS environment is accessed after the OS was accessed, any components, software, applications, and/or the like, that are only accessible through the OS, are no longer accessible in the pre-OS environment. The manual input received at the information handling device for accessing a device BIOS may include, for example, an input at a keyboard of the device, a combination of key and/or button selection present on an information handling device (e.g., a home button and a power button of a smartphone pushed simultaneously), and/or the like. Additionally, and/or alternatively, receiving an indication for entering a device BIOS may occur automatically upon powering-on an information handling device. For example, a device may be previously programmed may provide access to the BIOS of a device each time a device is power-on.

An indication for entering device BIOS may include instructions to access a BIOS menu of the device. A BIOS menu may be an initial display of accessible software components of the BIOS of an information handling device while in a pre-OS operating environment. Software components such as hardware initialization order, application booting order, and/or the like, may be accessible in a pre-OS environment, and may not be accessible when an OS environment is active. Therefore, accessing a BIOS of a device can provide a user with an ability to influence aspects of a device that may influence operation of the device and can only be accessed in a pre-OS environment.

Since accessing BIOS of a device occurs in a pre-OS environment, components that rely on an operating system may be disabled when accessing the BIOS. Traditionally, components that address disabilities, for example, visual impairment, may not be active while a device is operating in a pre-OS environment. This may greatly influence a user's ability to move through the BIOS of a device. Information contained within the BIOS of a device is primarily provided as information presented on a display of the information handling device. Thus, for example, when a visually impaired user is attempting to access the BIOS of a device, a user may not be able to view the information of the BIOS and any assisting devices that may supply information to a visually impaired user may not be utilized while in the pre-OS environment.

Subsequent to receiving an indication for entering the BIOS of a device in a pre-operating system environment, the system may present a BIOS menu including a plurality of system software components at 302. As mentioned above, a BIOS menu is commonly provided as a presentation of information present on a display integrally coupled to an information handling device. Additionally, and/or alternatively, presenting a BIOS menu does not require a presentation of information on a display. However, for ease of understanding of the system and method described herein, reference to presenting BIOS information on a display will be utilized. This is intended as a non-limiting example for BIOS menu presentation.

While operating in a pre-OS environment, presenting a BIOS menu including a plurality of system software components may include displaying an outline of the system software components on a display of an information handling device. For example, one system software component may be directed to a firmware description of the device in use. In the described system and in order to assist in overcoming some visual impairments, presenting a BIOS menu may include accounting for a level of visual impairment or certain visual conditions of a user attempting to access the BIOS menu. As an example, for a user that may have a partial visual impairment and/or a visual impairment associated with color depiction, a BIOS menu may be altered to overcome such visual impairments.

For example, a user that is colorblind and cannot see the color blue, which is the most common BIOS menu color on a device, the system may alter a BIOS menu color to one that can be more clearly perceived by the user. Additionally, and/or alternatively, the system may alter a display component when presenting a BIOS menu comprising a plurality of system software components to include adjusting font style, font size, font color, and/or the like, which may present more contrast, larger text, and/or the like which may be easier to perceive by the user. Additionally, and/or alternatively, altering a display component when presenting a BIOS menu may include repositioning software components outlined on the BIOS menu, utilizing icons over software terminology, removing lengthy descriptions of software components, and/or the like, in order to reduce the amount of information that has to be visually perceived by the user. No matter how a BIOS menu is presented to a user, the BIOS menu is only accessible in a pre-OS environment.

A user may then select a software component from the plurality of system software components of the BIOS menu while in a pre-operating system environment at 303. Selection of a software component may be performed utilizing one or more device components that are accessible while a device is operating in a pre-OS environment. For example, similar to receiving in indication at 301, selecting a software component on a BIOS menu may include providing a manual input at the information handling device utilizing a peripheral device that is integrally coupled to a device. For example, a keyboard may be labeled as a peripheral device but may be determined to be integral for use of the device. Since a device is operating in a pre-OS environment, selection of a software component from a plurality of system software components may be limited to peripheral devices deemed integral for the operation of the information handling device, and generally includes only a keyboard and may possibly include a mouse.

The system and method may then determine if a user has selected a software component present on the BIOS menu at 303. When it is determined that a selection has not occurred, the system and method will not provide an audible description of a software component present on a BIOS menu to the user at 304. Thus, without a selection at 303, the system may take no further action at 304 and continue to wait for a selection at 303 or some action that may exit the pre-operating system environment. Additionally, when it is determined that a selection of a software component has not occurred, the system may continue to present the BIOS menu of a display of an information handling device until an action is taken by the user. Additionally, and/or alternatively, when it is determined that a selection of a software component has not occurred, the system may present the BIOS menu on a display of an information handling device for a predetermined amount of time. Then, when it is determined that the predetermined amount of time of inactivity has occurred, the device may perform a predetermined action, for example, turn off a device, activate an operating system of the device, provide a notification to a user requesting input for instruction, and/or the like.

On the other hand, when it is determined that a selection of a software component has occurred at 303, a device may provide an audible description of the software component to the user at 305. Subsequent to the selection of a software component from the BIOS menu, the system may determine the content of the software component selected. A screen reader device of the information handling device that is permitted to operate in pre-OS environment may determine the content of the selected component and thereafter provide an audible description of the software component to a user. A screen reader is a device component that may analyze and digest the information selected and provide audio to a user in response to the software component selection. Therefore, when a visually impaired user has selected a software component present on a BIOS menu, a screen reader device can describe the selection to the user further assisting the visually impaired user in understanding what is present on the BIOS menu.

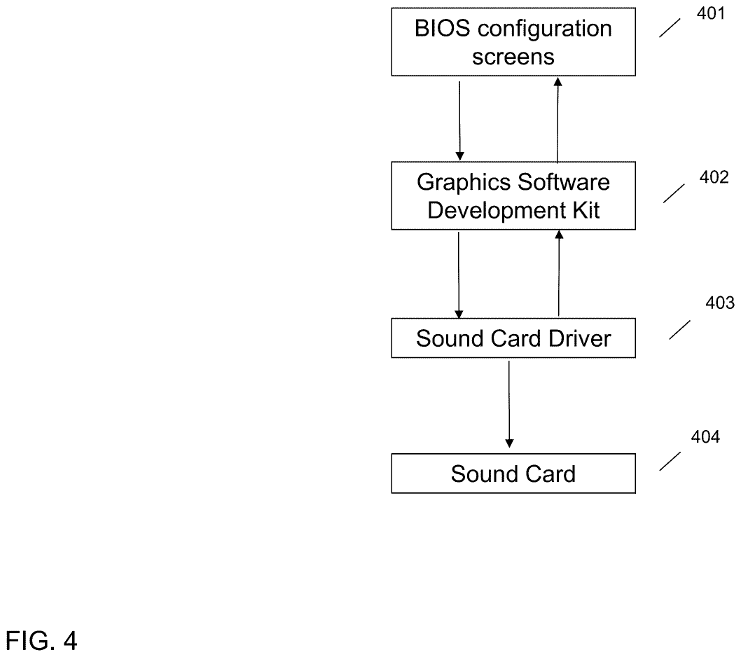

As mentioned previously, traditional screen reader devices fall into a category of devices that require an operating system to be active in order to be utilized. However, as will be described further herein, the system has established a method permitting the utilization of a screen reader in a pre-operating system environment. When providing an audible description of the software component utilizing a screen reader device, audio describing the software component may be outputted by an audio device coupled to the information handling device. Thus, providing an audible output in a pre-OS environment supplies a visually impaired, and/or a completely blind, user with a description of software components present on BIOS menu and may permit the visually impaired user to move through a BIOS menu with ease. How a screen reader system in a pre-operating system environment operates in described in FIG. 4.

FIG. 4 provides an example illustration of a screen reader architecture that operates in a pre-operating system environment. Rather than relying on an operating system of a device to be active, the screen reader device disclosed here is accessible through a unified extensible firmware interface BIOS present on an information handling device. Referring to FIG. 4, a BIOS configuration screen 401 may be included in a UEFI. As disclosed previously, when a user accesses an information handling device BIOS, and/or a BIOS menu, the information handling device is determined to be in a pre-operating system environment. This pre-OS will limit the number of actions an information handling device can perform and the amount of device components that are operable. For example, in a traditional system, a screen reader device of an information handling device will be inoperable in a pre-OS environment.

However, in order to utilize a screen reader device in a pre-OS environment, the system may integrate the UEFI environment with a basic application programing interface to the UEFI graphics in a software development kit. In other words, as is described in FIG. 4, BIOS configuration screens 401, graphics software development kit 402, and sound card driver 403 may be utilized in combination in order to be integrated into the unified extensible firmware interface. This unified extensible firmware interface can be utilized in a pre-operating system environment, thereby allowing the operation of the screen reader in the pre-OS environment. The BIOS configuration screen 401 is the BIOS menu of the information handling device. The software components outlined by the BIOS of the information handling device will identify what is accessible in the pre-operating system environment.

The graphics software development kit 402 is a tool present within a software development kit on the information handling device and is accessible in the pre-OS environment. A software development kit is a collection of tools that permits the building and/or functioning of device applications (e.g., operating system, programming language, etc.). The software development kit may assemble and group together components directed to a specific application. Therefore, when integrated into the UEFI environment, the graphics software development kit 402 may assist in determining what to display on the BIOS configuration screens 401.

Additionally, and also integrated into the UEFI environment of the information handling device, sound card driver 403 may be utilized in combination with BIOS configuration screens 401 and graphics software development kit 402 in order to permit communication of such displayed information with audio devices coupled to the information handling device. Sound card driver may direct any sound produced, for example, a description of a software component present on a BIOS configuration screen 401, and/or a BIOS menu, of the information handling device to an audio output device. Since the sound card driver 403 is integrated into the UEFI environment of the information handling device, a sound card driver is also permitted to operate in a pre-OS environment.

The BIOS configuration screens 401 that may identify what is present on a BIOS menu of an information handling device operating in a pre-OS environment, the graphics development kit 402 that may display the BIOS menu information on a display of the information handling device, and the sound card driver 403 that may direct any sound generation to an audio output device, may then be pushed to sound card 404. A sound card 404 is responsible for generating audio for an information handling device. The combination of components 401, 402, and 403 may be pushed to sound card 404 subsequent to the selection of a software component from the plurality of software components on a BIOS menu while in a pre-operating system environment, as is disclosed in 303 of FIG. 3. With the foundation of these components present in a UEFI environment, the system will allow for the creation of a portable sound production application that can operate in a pre-operating system environment. Therefore, such a configuration permits the use of a screen reader application that may respond to a selection input and provide an audible description of the software component to a user in a pre-operating system environment.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, at an information handling device in a pre-operating system environment, an indication to access a BIOS of the information handling device;
presenting, in the pre-operating system environment, a BIOS menu comprising a plurality of system software components;
receiving, at the BIOS menu while in the pre-operating system environment, a selection of a software component from the plurality of software components; and
providing, in response to the selection and utilizing a screen reader device, an audible description of the software component to a user.

2. The method of claim 1, wherein the receiving the indication comprises receiving a manual input at the information handling device prior to activating an operating system;
wherein the indication comprises instruction to access the BIOS menu of the device.

3. The method of claim 1, wherein the receiving the indication comprises powering-on the information handling device.

4. The method of claim 1, wherein the presenting the BIOS menu comprises displaying the BIOS menu on a display coupled to the information handling device.

5. The method of claim 1, wherein the presenting comprises automatically presenting the BIOS menu in response to powering-on the information handling device.

6. The method of claim 1, wherein the selecting the software component comprises providing manual input at the information handling device;
wherein the manual input comprises utilizing a peripheral device coupled to the device displaying the BIOS menu.

7. The method of claim 1, wherein the selecting comprises determining content of the software component.

8. The method of claim 1, wherein the providing the audible input comprises outputting, using an audio output device coupled to the information handling device, audio describing the software component selected.

9. The method of claim 1, further comprising activating an operating system upon completion of the providing the audible description of the software component.

10. A device, the device comprising:
a processor;
a memory device that stores instructions that, when executed by the processor, causes the device to:
receive, in a pre-operating system environment, an indication to access a BIOS of the device;
present, in the pre-operating system environment, a BIOS menu comprising a plurality of system software components;
receive, at the BIOS menu while in the pre-operating system environment, a selection of a software component from the plurality of software components; and
provide, in response to the selection and utilizing a screen reader device, an audible description of the software component to a user.

11. The device of claim 10, wherein to receive the indication comprises receiving a manual input at the device prior to activating an operating system;
wherein the indication comprises instruction to access the BIOS menu of the device.

12. The device of claim 10, wherein to present the BIOS menu comprises displaying the BIOS menu on the display of the device.

13. The device of claim 10, wherein to present the BIOS menu comprises displaying the BIOS menu with an altered display.

14. The device of claim 13, wherein the altered display comprises one or more adjusted display components to account for a user's disability.

15. The device of claim 10, wherein to present comprises automatically displaying the BIOS menu in response to powering on the device.

16. The device of claim 10, wherein to select the software component comprises providing manual input at the information handling device;
wherein the manual input comprises utilizing a peripheral device coupled to the device displaying the BIOS menu.

17. The device of claim 10, wherein to select comprises determining content of the software component.

18. The device of claim 10, wherein to provide the audible input comprises outputting, using an audio output device coupled to the information handling device, audio describing the software component selected.

19. The device of claim 10, wherein the screen reader device comprises an integrated unified extensible firmware interface environment;
wherein the unified extensible firmware interface environment comprises a software development kit including an application programming interface and unified extensible firmware graphics that pairs the software development kit with sound output operations.

20. A product, the product comprising:
a computer-readable storage device that stores code that, when executed by a processor, causes the product to:
receive, in a pre-operating system environment, an indication to access a BIOS of an information handling device;
present, in the pre-operating system environment, a BIOS menu comprising a plurality of system software components;
receive, at the BIOS menu while in the pre-operating system environment, a selection of a software component from the plurality of software components; and
provide, in response to the selection and utilizing a screen reader device, an audible description of the software component to a user.
